(19) United States
(12) Patent Application Publication
(10) Pub. No.: US 2025/0065934 A1
(43) Pub. Date: Feb. 27, 2025

(54) TWO-TIER CART

(71) Applicant: Jinhua Shanmu Leisure Products Co., Ltd., Jinhua (CN)

(72) Inventor: Xiangshan ZHANG, Jinhua (CN)

(73) Assignee: Jinhua Shanmu Leisure Products Co., Ltd., Jinhua (CN)

(21) Appl. No.: 18/386,613

(22) Filed: Nov. 3, 2023

(30) Foreign Application Priority Data
Aug. 21, 2023 (CN) 202322237453.3

(51) Int. Cl. B62B 3/00; B62B 3/02; B62B 5/06

(52) U.S. Cl. CPC B62B 3/007; B62B 3/022; B62B 5/065; B62B 2205/06

(57) ABSTRACT

A two-tier cart includes a first column, a second column, a third column, a fourth column, a first bottom support mechanism, a second bottom support mechanism, and a plurality of folding mechanisms. The first column, the second column, the third column and the fourth column are rectangularly arranged at intervals, and lower ends thereof are all connected to the first bottom support mechanism, one folding mechanism is connected between two adjacent columns, and the folding mechanisms are capable of being folded and contracted. The first column, the second column, the third column and the fourth column are all connected to the second bottom support mechanism, the second bottom support mechanism is located above the first bottom support mechanism, and the first bottom support mechanism and the second bottom support mechanism are both capable of being folded and contracted upward.

### CROSS REFERENCE TO THE RELATED APPLICATIONS

This application is based upon and claims priority to Chinese Patent Application No. 202322237453.3, filed on Aug. 21, 2023, the entire contents of which are incorporated herein by reference.

### TECHNICAL FIELD

The present disclosure relates to the technical field of foldable carts, and in particular, to a two-tier cart.

### BACKGROUND

In daily life and production, it is often necessary to carry luggage or articles, and cart tools are often used. Carts are widely used because they can be pushed easily and thus save time and effort. To facilitate cart storage, the cart is designed into a foldable structure, which is very light. After being folded, it can be placed in a car or a backpack. It takes up little space and is easy to carry. However, the existing foldable cart is configured for only a whole storage space for articles, placement of the articles cannot be classified, and articles with large or irregular sizes cannot be placed.

### SUMMARY

### (I) Technical Problems to be Solved

To overcome the above shortcomings of the prior art, the present disclosure provides a two-tier cart, which solves the technical problems that the cart is inconvenient for classified placement of articles and cannot place articles with large or irregular sizes.

### (II) Technical Solutions

To achieve the above objective, the present disclosure provides a two-tier cart. The two-tier cart includes a first column, a second column, a third column, a fourth column, a first bottom support mechanism, a second bottom support mechanism, and a plurality of folding mechanisms, where
the first column, the second column, the third column and the fourth column are rectangularly arranged at intervals, and lower ends thereof are all connected to the first bottom support mechanism, one folding mechanism is connected between two adjacent columns, and the folding mechanisms are capable of being folded and contracted; and
the first column, the second column, the third column and the fourth column are all connected to the second bottom support mechanism, the second bottom support mechanism is located above the first bottom support mechanism, and the first bottom support mechanism and the second bottom support mechanism are both capable of being folded and contracted upward.

Optionally, the two-tier cart further includes a rear frame mechanism, where the rear frame mechanism is disposed between the second column and the third column, and a lower end of the rear frame mechanism is rotatably connected to the lower end of the second column and the lower end of the third column by a limited angle.

Optionally, the rear frame mechanism includes a first rear frame column, a second rear frame column, and a rear frame folding assembly; and
the rear frame folding assembly is connected between the first rear frame column and the second rear frame column, a first end of the first rear frame column is rotatably connected to the lower end of the second column by a limited angle, and a first end of the second rear frame column is rotatably connected to the lower end of the third column by a limited angle.

Optionally, the first rear frame column and the second rear frame column are each slidably provided with a laying-down slide sleeve, a second end of the first rear frame column and a second end of the second rear frame column are each provided with a laying-down fastener, the laying-down fastener and the laying-down slide sleeve on the first rear frame column are both connected to the rear frame folding assembly, and the laying-down fastener and the laying-down slide sleeve on the second rear frame column are both connected to the rear frame folding assembly; and
the laying-down slide sleeve is provided with a clamping assembly, and the clamping assembly on the first rear frame column and the clamping assembly on the second rear frame column are capable of being clamped in one-to-one correspondence with the second column and the third column.

Optionally, the rear frame folding assembly includes a first cross bent tube, a second cross bent tube, a first cross straight tube, and a second cross straight tube;
the first cross bent tube is rotatably connected to the second cross bent tube, a first end of the first cross bent tube is rotatably connected to the laying-down fastener on the first rear frame column, and a first end of the second cross bent tube is rotatably connected to the laying-down slide sleeve on the first rear frame column;
the first cross straight tube is rotatably connected to the second cross straight tube, a first end of the first cross straight tube is rotatably connected to the laying-down fastener on the second rear frame column, and a first end of the second cross straight tube is rotatably connected to the laying-down slide sleeve on the second rear frame column; and
a second end of the first cross bent tube is rotatably connected to a second end of the first cross straight tube, and a second end of the second cross bent tube is rotatably connected to a second end of the second cross straight tube.

Optionally, the two-tier cart further includes a first linkage slide sleeve, a second linkage slide sleeve, a third linkage slide sleeve, and a fourth linkage slide sleeve, where the first linkage slide sleeve, the second linkage slide sleeve, the third linkage slide sleeve and the fourth linkage slide sleeve are slidably connected in one-to-one correspondence with the first column, the second column, the third column and the fourth column;
the first linkage slide sleeve, the second linkage slide sleeve, the third linkage slide sleeve and the fourth linkage slide sleeve are all hinged to the second bottom support mechanism; and
both ends of the folding mechanism connected to the first column and the second column are connected in one-to-one correspondence with the first linkage slide sleeve and the second linkage slide sleeve; both ends of the folding mechanism connected to the second column and the third column are connected in one-to-one correspondence with the second linkage slide sleeve and the third linkage slide sleeve; both ends of the folding mechanism connected to the third column and the fourth column are connected in one-to-one correspondence with the third linkage slide sleeve and the fourth linkage slide sleeve; and both ends of the folding mechanism connected to the fourth column and the first column are connected in one-to-one correspondence with the fourth linkage slide sleeve and the first linkage slide sleeve.

Optionally, the second bottom support mechanism includes a first bottom connector, a first bottom connecting tube, a second bottom connecting tube, a third bottom connecting tube, and a fourth bottom connecting tube; the first bottom support mechanism includes a second bottom connector, a fifth bottom connecting tube, a sixth bottom connecting tube, a seventh bottom connecting tube, and an eighth bottom connecting tube;
first ends of the fifth bottom connecting tube, the sixth bottom connecting tube, the seventh bottom connecting tube and the eighth bottom connecting tube are all rotatably connected to the second bottom connector by a limited angle; second ends of the fifth bottom connecting tube, the sixth bottom connecting tube, the seventh bottom connecting tube and the eighth bottom connecting tube are rotatably connected in one-to-one correspondence with the lower ends of the first column, the second column, the third column and the fourth column; and
first ends of the first bottom connecting tube, the second bottom connecting tube, the third bottom connecting tube and the fourth bottom connecting tube are all rotatably connected to the first bottom connector by a limited angle; and second ends of the first bottom connecting tube, the second bottom connecting tube, the third bottom connecting tube and the fourth bottom connecting tube are rotatably connected in one-to-one correspondence with the first linkage slide sleeve, the second linkage slide sleeve, the third linkage slide sleeve and the fourth linkage slide sleeve.

Optionally, when the two-tier cart is in an unfolded state, a folded state, or in a process of being folded, the first bottom connecting tube, the second bottom connecting tube, the third bottom connecting tube and the fourth bottom connecting tube are always parallel to the fifth bottom connecting tube, the sixth bottom connecting tube, the seventh bottom connecting tube and the eighth bottom connecting tube in one-to-one correspondence;
when the two-tier cart is in the folded state, the first bottom connecting tube, the second bottom connecting tube, the third bottom connecting tube and the fourth bottom connecting tube are folded into a first tetrapyramid structure, the fifth bottom connecting tube, the sixth bottom connecting tube, the seventh bottom connecting tube and the eighth bottom connecting tube are folded into a second tetrapyramid structure, and the second tetrapyramid structure is sleeved in the first tetrapyramid structure; and
when the two-tier cart is in the folded state, a horizontal height of the first bottom connector is not higher than a horizontal height of an upper end of the first column.

Optionally, the plurality of folding mechanisms include: a first folding mechanism connected between the first column and the second column, a second folding mechanism connected between the third column and the fourth column, a third folding mechanism connected between the first column and the fourth column, and a fourth folding mechanism connected between the second column and the third column;
the first folding mechanism and the second folding mechanism each include a first linkage, a second linkage, a third linkage, a fourth linkage, a fifth linkage, and a sixth linkage;
the first linkage, the second linkage and the third linkage are rotatably connected end to end in sequence; the fourth linkage, the fifth linkage and the sixth linkage are rotatably connected end to end in sequence; a middle of the first linkage is rotatably connected to a middle of the fourth linkage, a middle of the second linkage is rotatably connected to a middle of the fifth linkage, and a middle of the third linkage is rotatably connected to a middle of the sixth linkage;
the first linkage of the first folding mechanism is rotatably connected to an upper end of the first column, the third linkage of the first folding mechanism is rotatably connected to the second linkage slide sleeve, the first linkage of the second folding mechanism is rotatably connected to an upper end of the fourth column, and the third linkage of the second folding mechanism is rotatably connected to the third linkage slide sleeve;
the fourth linkage of the first folding mechanism is rotatably connected to the first linkage slide sleeve, the sixth linkage of the first folding mechanism is rotatably connected to an upper end of the second column, the fourth linkage of the second folding mechanism is rotatably connected to the fourth linkage slide sleeve, and the sixth linkage of the second folding mechanism is rotatably connected to an upper end of the third column;
the third folding mechanism and the fourth folding mechanism each include a seventh linkage, an eighth linkage, a ninth linkage, and a tenth linkage;
a first end of the seventh linkage is rotatably connected to a first end of the eighth linkage, a first end of the ninth linkage is rotatably connected to a first end of the tenth linkage, a body of the seventh linkage is rotatably connected to a body of the ninth linkage, and a body of the eighth linkage is rotatably connected to a body of the tenth linkage;
a second end of the seventh linkage of the third folding mechanism is rotatably connected to the upper end of the first column, a second end of the eighth linkage of the third folding mechanism is rotatably connected to the upper end of the fourth column, a second end of the ninth linkage of the third folding mechanism is rotatably connected to the first linkage slide sleeve, and a second end of the tenth linkage of the third folding mechanism is rotatably connected to the fourth linkage slide sleeve; and
a second end of the seventh linkage of the fourth folding mechanism is rotatably connected to the upper end of the second column, a second end of the eighth linkage of the fourth folding mechanism is rotatably connected to the upper end of the third column, a second end of the ninth linkage of the fourth folding mechanism is rotatably connected to the second linkage slide sleeve, and a second end of the tenth linkage of the fourth folding mechanism is rotatably connected to the third linkage slide sleeve.

Optionally, the two-tier cart further includes a handle mechanism, where the handle mechanism includes a telescopic rod, a first connecting tube, and a second connecting tube, a first end of the first connecting tube and a first end of the second connecting tube are both rotatably connected to a first end of the telescopic rod by a limited angle, and a second end of the first connecting tube and a second end of the second connecting tube are rotatably connected in one-to-one correspondence with the lower end of the first column and the lower end of the fourth column.

### (III) Beneficial Effects

The first bottom support mechanism forms a first-tier cart structure, and a side surrounding structure is not provided on a side surface of the first-tier cart structure, facilitating the placement of articles with large or irregular sizes. Folding mechanisms are located above the second bottom support mechanism, and the second bottom support mechanism cooperates with the folding mechanisms to form a second-tier cart structure, facilitating the provision of a cloth container for holding small articles to avoid falling of the small articles. The first bottom support mechanism and the second bottom support mechanism are both capable of being folded and contracted upward, and the horizontal heights of the tops thereof after folding do not exceed the horizontal heights of the upper ends of four columns, thereby ensuring invariable height of the two-tier cart in a folded state or an unfolded state, effectively reducing the folding volume of the two-tier cart, and facilitating packaging, transportation and storage by users.

The lower end of a rear frame mechanism is rotatably connected to the lower ends of the second and third columns by a limited angle, the rear frame mechanism can only rotate from a vertical folded state to an approximately horizontal unfolded state, the rotation angle is smaller than 90 degrees, and the rear frame mechanism in the unfolded state effectively expands the area of the first bottom support mechanism, thereby expanding the first-tier support area of the two-tier cart, facilitating the placement of larger or longer articles on the first tier, and improving the flexibility of the cart.

### BRIEF DESCRIPTION OF THE DRAWINGS

FIG. 1 is a stereogram of a two-tier cart in an unfolded state according to the present disclosure;

FIG. 2 is a schematic structural diagram of a two-tier cart in an unfolded state according to the present disclosure;

FIG. 3 is a top view of a two-tier cart in an unfolded state according to the present disclosure;

FIG. 4 is a front view of a two-tier cart in an unfolded state according to the present disclosure;

FIG. 5 is a left view of a two-tier cart in an unfolded state according to the present disclosure;

FIG. 6 is a bottom view of a two-tier cart in an unfolded state according to the present disclosure;

FIG. 7 is a front view of a two-tier cart in a half-folded state according to the present disclosure;

FIG. 8 is a front view of a two-tier cart in a folded state according to the present disclosure;

FIG. 9 is a left view of a two-tier cart in a half-folded state according to the present disclosure; and

FIG. 10 is a left view of a two-tier cart in a folded state according to the present disclosure.

### REFERENCE NUMERALS

11: First column; 12: Second column; 13: Third column; 14: Fourth column;
21: First bottom support mechanism; 210: Second bottom connector; 211: Fifth bottom connecting tube; 212: Sixth bottom connecting tube; 213: Seventh bottom connecting tube; 214: Eighth bottom connecting tube;
22: Second bottom support mechanism; 220: First bottom connector; 221: First bottom connecting tube; 222: Second bottom connecting tube; 223: Third bottom connecting tube; 224: Fourth bottom connecting tube;
30: Rear frame mechanism; 301: First rear frame column; 302: Second rear frame column; 303: Rear frame folding assembly; 3031: First cross bent tube; 3032: Second cross bent tube; 3033: First cross straight tube; 3034: Second cross straight tube; 304: Laying-down slide sleeve; 305: Laying-down fastener; 306: Clamping assembly;
40: Folding mechanism; 41: First folding mechanism; 411: First linkage; 412: Second linkage; 413: Third linkage; 414: Fourth linkage; 415: Fifth linkage; 416: Sixth linkage; 42: Second folding mechanism; 43: Third folding mechanism; 431: Seventh linkage; 432: Eighth linkage; 433: Ninth linkage; 434: Tenth linkage; 44: Fourth folding mechanism;
51: First linkage slide sleeve; 52: Second linkage slide sleeve; 53: Third linkage slide sleeve; 54: Fourth linkage slide sleeve;
60: Handle; 601: Telescopic rod; 602: First connecting tube; and 603: Second connecting tube.

### DETAILED DESCRIPTION OF THE EMBODIMENTS

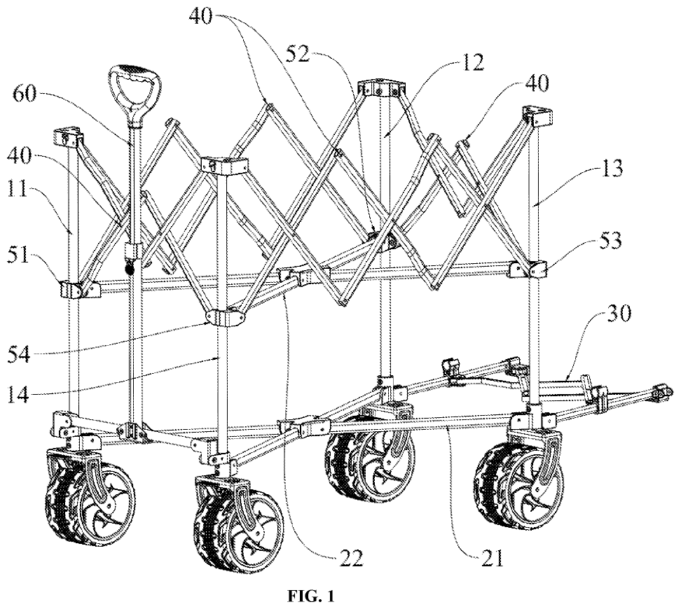

In order to better explain the present disclosure and facilitate understanding, the present disclosure is described in detail below with reference to the drawings and specific implementations. The terms such as “upper” and “lower” mentioned herein are based on the orientations shown in FIG. 1.

Although the drawings show the exemplary embodiments of the present disclosure, it should be understood that the present disclosure may be implemented in various forms and should not be limited to the embodiments set forth herein. On the contrary, these embodiments are provided such that the present disclosure is more fully understandable, and fully conveys the scope of the present disclosure to those skilled in the art.

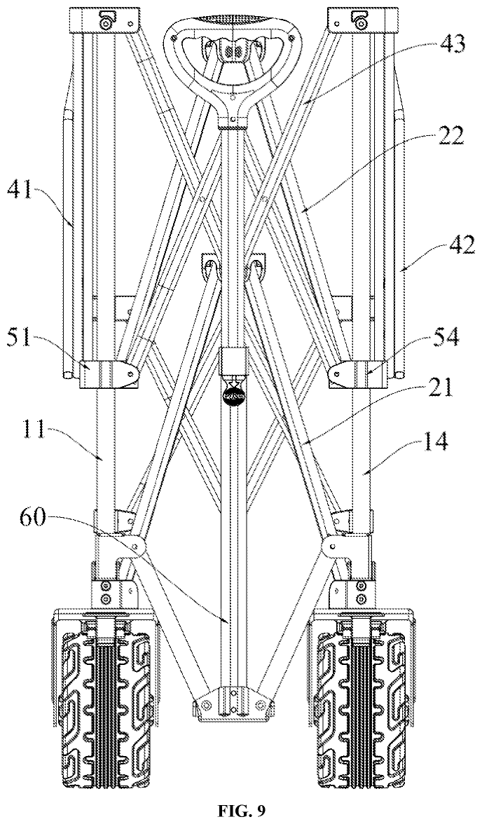

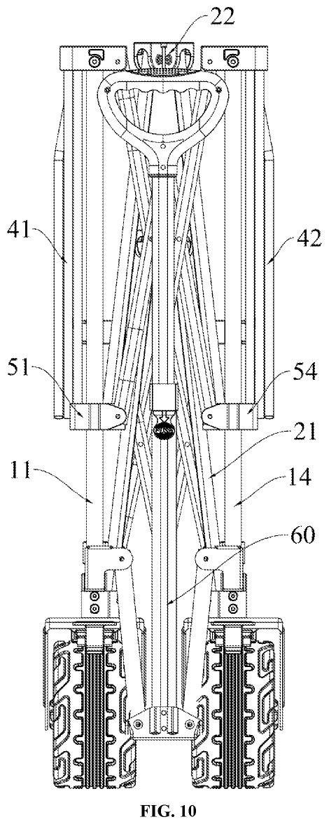

As shown in FIG. 1 to FIG. 10, the present disclosure provides a two-tier cart, including upper and lower tiers configured to place different types of articles, implementing classified placement of articles, and greatly facilitating the taking and placement of articles by users. The two-tier cart includes first column 11, second column 12, third column 13, fourth column 14, first bottom support mechanism 21, second bottom support mechanism 22, and a plurality of folding mechanisms 40. The two-tier cart includes a folded state and an unfolded state, and can be switched between the two states. In the folded state and the unfolded state, the first column 11, the second column 12, the third column 13 and the fourth column 14 are rectangularly arranged at intervals, the first bottom support mechanism 21 and the second bottom support mechanism 22 are located in a region defined by the four columns, and lower ends of the four columns are all connected to the first bottom support mechanism 21. The first bottom support mechanism 21 forms a first-tier cart structure, and a side surrounding structure is not provided on a side surface of the first-tier cart structure, facilitating the placement of articles with large or irregular sizes. One folding mechanism 40 is connected between two adjacent columns, and the folding mechanisms 40 are capable of being folded and contracted. When the two-tier cart is in the folded state, one folding mechanism 40 is extruded and contracted between two adjacent columns to reduce the folding volume of the two-tier cart. When the two-tier cart is in the unfolded state, the two-tier cart is in use now, and one folding mechanism 40 is supported between two adjacent columns to form the side surrounding structure of the two-tier cart. The first column 11, the second column 12, the third column 13 and the fourth column 14 are all connected to the second bottom support mechanism 22. In the unfolded state, the second bottom support mechanism 22 and the first bottom support mechanism 21 are arranged in parallel, the second bottom support mechanism 22 is located above the first bottom support mechanism 21, the folding mechanisms 40 are located above the second bottom support mechanism 22, and the second bottom support mechanism 22 cooperates with the folding mechanisms 40 to form a second-tier cart structure, facilitating the provision of a cloth container for holding small articles to avoid falling of the small articles. The first bottom support mechanism 21 and the second bottom support mechanism 22 are both capable of being folded and contracted upward, and the horizontal heights of the tops thereof after folding do not exceed the horizontal heights of the upper ends of four columns, thereby ensuring invariable height of the two-tier cart in a folded state or an unfolded state, effectively reducing the folding volume of the two-tier cart, and facilitating packaging, transportation and storage by users.

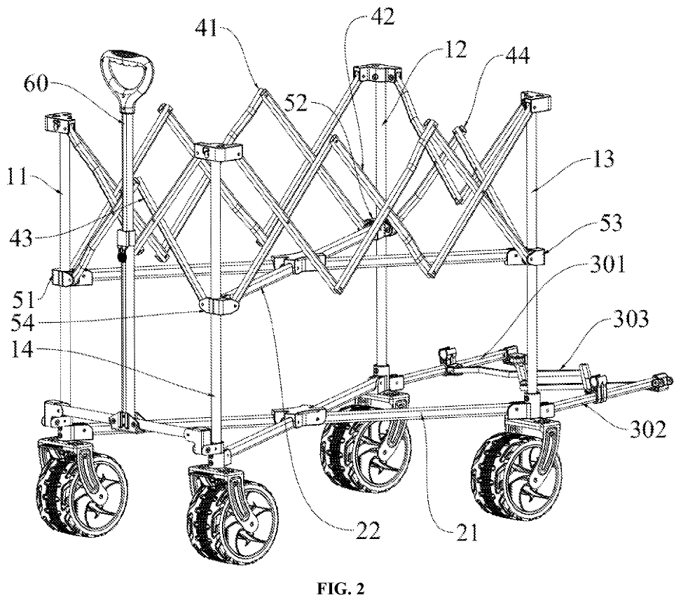

As shown in FIG. 2, rear frame mechanism 30 is provided between the second column 12 and the third column 13. The lower end of the rear frame mechanism 30 is rotatably connected to the lower ends of the second and third columns 12 and 13 by a limited angle, the rear frame mechanism 30 can only rotate from a vertical folded state to an approximately horizontal unfolded state, the rotation angle is smaller than 90 degrees, and the rear frame mechanism 30 in the unfolded state effectively expands the area of the first bottom support mechanism 21, thereby expanding the first-tier support area of the two-tier cart, facilitating the placement of larger or longer articles on the first tier, and improving the flexibility of the cart.

As shown in FIG. 2, the rear frame mechanism 30 includes first rear frame column 301, second rear frame column 302, and rear frame folding assembly 303. The rear frame folding assembly 303 is connected between the first rear frame column 301 and the second rear frame column 302. Along with the unfolding and folding of the two-tier cart, the rear frame folding assembly 303 is correspondingly folded and unfolded, thereby reducing the folding volume of the rear frame mechanism 30. A first end of the first rear frame column 301 is rotatably connected to the lower end of the second column 12 by a limited angle, and a first end of the second rear frame column 302 is rotatably connected to the lower end of the third column 13 by a limited angle. Specifically, the lower end of the second column 12 and the lower end of the third column 13 are each provided with a limiting arm, a limiting groove having an upward opening is formed in the limiting groove, the limiting groove passes through the entire limiting arm, and a bottom of the limiting groove is approximately horizontal. The first end of the first rear frame column 301 and the first end of the second rear frame column 302 are rotatably connected to the limiting groove in the second column 12 and the limiting groove in the third column 13 through rotating shafts, respectively. When the first rear frame column 301 and the second rear frame column 302 are unfolded and then clamped into the limiting grooves, the body at the first end abuts against the bottom and therefore cannot rotate anymore, thereby ensuring that the first rear frame column 301 and the second rear frame column 302 have a support force to place articles, and expanding the support area of the first bottom support mechanism 21.

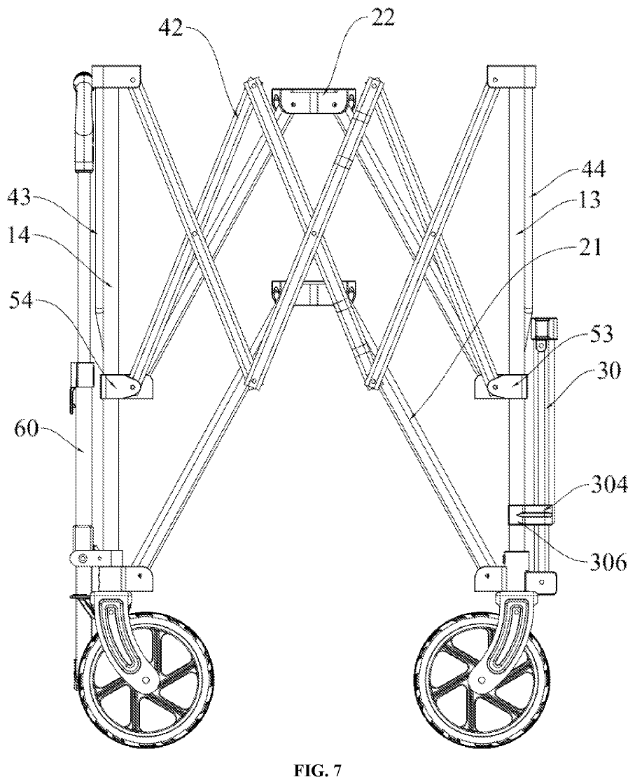

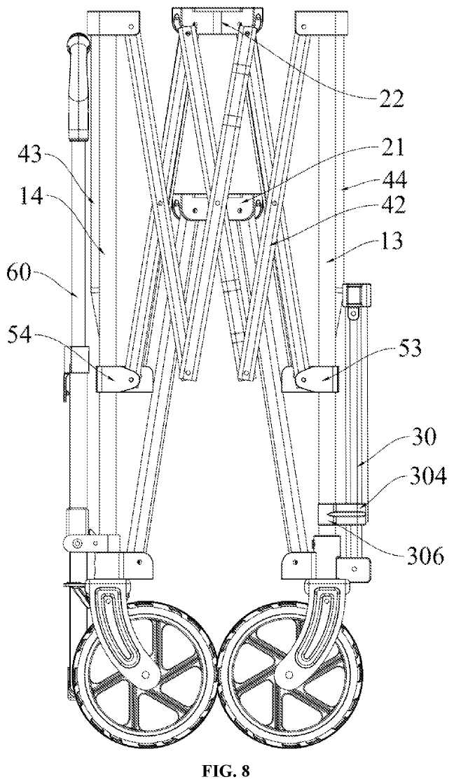

As shown in FIG. 2 to FIG. 4, FIG. 7, and FIG. 8, the first rear frame column 301 and the second rear frame column 302 are each slidably provided with laying-down slide sleeve 304 capable of sliding on a column, a second end of the first rear frame column 301 and a second end of the second rear frame column 302 are each provided with laying-down fastener 305, the laying-down fastener 305 and the laying-down slide sleeve 304 on the first rear frame column 301 are both connected to a first end of the rear frame folding assembly 303, and the laying-down fastener 305 and the laying-down slide sleeve 304 on the second rear frame column 302 are both connected to a second end of the rear frame folding assembly 303. The laying-down slide sleeve 304 is provided with clamping assembly 306. The clamping assembly 306 includes a connecting portion and a clamping portion connected to each other. The connecting portion is connected to the laying-down slide sleeve 304, a clamping groove is formed in the clamping portion, and a notch is narrower than a middle of the groove. When a laying-down mechanism is in a folded state, the clamping portions on the first rear frame column 301 and the second rear frame column 302 are clamped with bodies of the second column 12 and the third column 13 in one-to-one correspondence, and when there is no external force, the clamping portions and the corresponding columns are kept in stable connections. In a preferred implementation, the connecting portions and the clamping portions are integrally formed with the laying-down slide sleeve 304, and are slidably arranged on the corresponding columns through the laying-down slide sleeve 304.

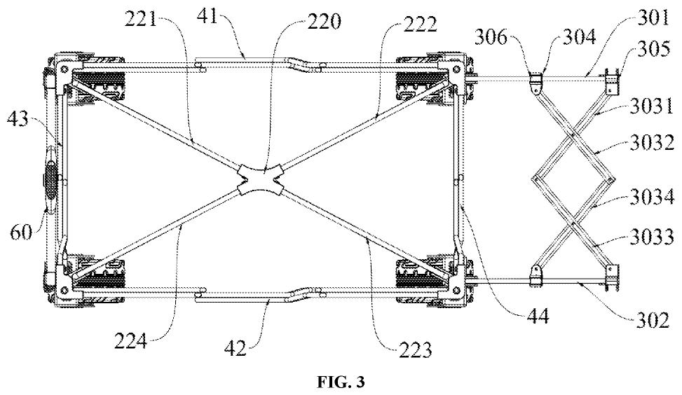

As shown in FIG. 3, the rear frame folding assembly 303 includes first cross bent tube 3031, second cross bent tube 3032, first cross straight tube 3033, and second cross straight tube 3034. The first cross bent tube 3031 is rotatably connected to a middle of a body of the second cross bent tube 3032 through a rotating shaft, a first end of the first cross bent tube 3031 is rotatably connected to the laying-down fastener 305 on the first rear frame column 301 through a rotating shaft, and a first end of the second cross bent tube 3032 is rotatably connected to the laying-down slide sleeve 304 on the first rear frame column 301 through a rotating shaft. The first cross straight tube 3033 is rotatably connected to a middle of a body of the second cross straight tube 3034 through a rotating shaft, a first end of the first cross straight tube 3033 is rotatably connected to the laying-down fastener 305 on the second rear frame column 302 through a rotating shaft, and a first end of the second cross straight tube 3034 is rotatably connected to the laying-down slide sleeve 304 on the second rear frame column 302 through a rotating shaft. A second end of the first cross bent tube 3031 is rotatably connected to a second end of the first cross straight tube 3033 through a rotating shaft, and a second end of the second cross bent tube 3032 is rotatably connected to a second end of the second cross straight tube 3034 through a rotating shaft. When the two-tier cart is folded, the rear frame folding assembly 303 is folded at the same time, the first rear frame column 301 and the second rear frame column 302 approach each other, the laying-down slide sleeve 304 slides downward, and the first cross bent tube 3031, the second cross bent tube 3032, the first cross straight tube 3033 and the second cross straight tube 3034 cross each other and rotate to a limit position. Due to the restriction of the rear frame folding assembly 303, the laying-down slide sleeve 304 cannot rotate when sliding along the columns, thereby ensuring that the clamping grooves in the clamping portions always face the second column 12 and the third column 13.

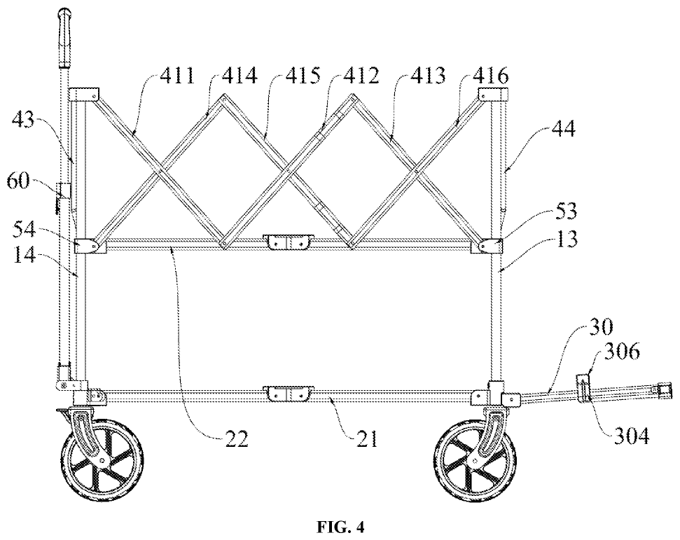

As shown in FIG. 2, FIG. 4, and FIG. 7 to FIG. 10, the two-tier cart further includes first linkage slide sleeve 51, second linkage slide sleeve 52, third linkage slide sleeve 53, and fourth linkage slide sleeve 54. The first linkage slide sleeve 51, the second linkage slide sleeve 52, the third linkage slide sleeve 53 and the fourth linkage slide sleeve 54 are slidably connected in one-to-one correspondence with the first column 11, the second column 12, the third column 13 and the fourth column 14, and can slide up and down along the columns. The first linkage slide sleeve 51, the second linkage slide sleeve 52, the third linkage slide sleeve 53 and the fourth linkage slide sleeve 54 are all hinged to the second bottom support mechanism 22, and the second bottom support mechanism 22 is supported through the four linkage slide sleeves. Both ends of the folding mechanism 40 connected to the first column 11 and the second column 12 are connected in one-to-one correspondence with the first linkage slide sleeve 51 and the second linkage slide sleeve 52; both ends of the folding mechanism 40 connected to the second column 12 and the third column 13 are connected in one-to-one correspondence with the second linkage slide sleeve 52 and the third linkage slide sleeve 53; both ends of the folding mechanism 40 connected to the third column 13 and the fourth column 14 are connected in one-to-one correspondence with the third linkage slide sleeve 53 and the fourth linkage slide sleeve 54; and both ends of the folding mechanism 40 connected to the fourth column 14 and the first column 11 are connected in one-to-one correspondence with the fourth linkage slide sleeve 54 and the first linkage slide sleeve 51.

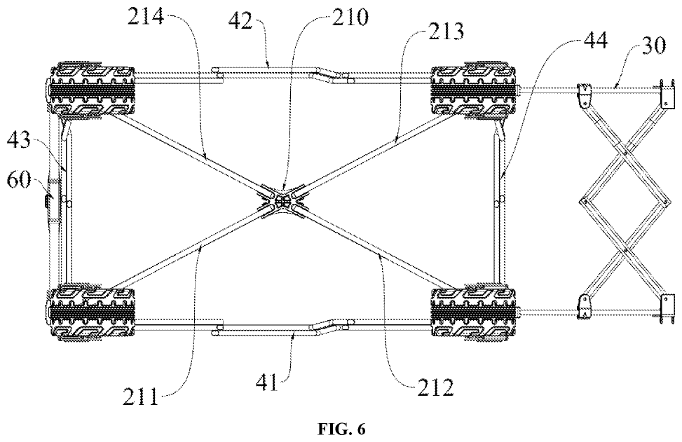

As shown in FIG. 3, the second bottom support mechanism 22 includes first bottom connector 220, first bottom connecting tube 221, second bottom connecting tube 222, third bottom connecting tube 223, and fourth bottom connecting tube 224. First ends of the first bottom connecting tube 221, the second bottom connecting tube 222, the third bottom connecting tube 223 and fourth bottom connecting tube 224 are all rotatably connected to the first bottom connector 220 by a limited angle. The first bottom connector 220 includes four connecting arms, and the connecting arms are provided with limiting grooves having downward openings and configured to restrict the bottom connecting tubes from rotating until tube bodies abut against bottoms of the limiting grooves, and at this time, the bottom connecting tubes are in a horizontal state. Second ends of the first bottom connecting tube 221, the second bottom connecting tube 222, the third bottom connecting tube 223 and the fourth bottom connecting tube 224 are rotatably connected in one-to-one correspondence with the first linkage slide sleeve 51, the second linkage slide sleeve 52, the third linkage slide sleeve 53 and the fourth linkage slide sleeve 54. In the folding process of the two-tier cart, the first bottom connector 220 moves upward, the second ends of the bottom connecting tubes move downward along with the linkage slide sleeve, and the second ends of the four bottom connecting tubes are gathered. As shown in FIG. 6, the first bottom support mechanism 21 includes second bottom connector 210, fifth bottom connecting tube 211, sixth bottom connecting tube 212, seventh bottom connecting tube 213, and eighth bottom connecting tube 214. First ends of the fifth bottom connecting tube 211, the sixth bottom connecting tube 212, the seventh bottom connecting tube 213 and eighth bottom connecting tube 214 are all rotatably connected to the second bottom connector 210 by a limited angle. The connecting form between the bottom connecting tubes and the second connector is the same as that in the second bottom support mechanism 22, which is not repeated herein again. Second ends of the fifth bottom connecting tube 211, the sixth bottom connecting tube 212, the seventh bottom connecting tube 213 and the eighth bottom connecting tube 214 are rotatably connected in one-to-one correspondence with fasteners at the lower ends of the first column 11, the second column 12, the third column 13 and the fourth column 14. When the cart is folded, the second bottom connector 210 moves upward, and the second ends of the bottom connecting tubes are gathered. When the two-tier cart is in an unfolded state, a folded state, or in a process of being folded, the first bottom connecting tube 221, the second bottom connecting tube 222, the third bottom connecting tube 223 and the fourth bottom connecting tube 224 are always parallel to the fifth bottom connecting tube 211, the sixth bottom connecting tube 212, the seventh bottom connecting tube 213 and the eighth bottom connecting tube 214 in one-to-one correspondence. When the two-tier cart is in the folded state, the first bottom connecting tube 221, the second bottom connecting tube 222, the third bottom connecting tube 223 and the fourth bottom connecting tube 224 are folded into a first tetrapyramid structure, and the first bottom connecting tube 221, the second bottom connecting tube 222, the third bottom connecting tube 223 and the fourth bottom connecting tube 224 respectively serve as four edges of the first tetrapyramid. The fifth bottom connecting tube 211, the sixth bottom connecting tube 212, the seventh bottom connecting tube 213 and the eighth bottom connecting tube 214 are folded into a second tetrapyramid structure, and the fifth bottom connecting tube 211, the sixth bottom connecting tube 212, the seventh bottom connecting tube 213 and the eighth bottom connecting tube 214 respectively serve as four edges of the second tetrapyramid. The second tetrapyramid structure is sleeved in the first tetrapyramid structure, thereby avoiding mutual interference between the first bottom support mechanism 21 and the second bottom support mechanism 22 in the folding process of the two-tier cart. When the two-tier cart is in the folded state, a horizontal height of the first bottom connector 220 is not higher than a horizontal height of the upper end of the first column 11, thereby ensuring an invariable height after folding.

As shown in FIG. 4, the plurality of folding mechanisms 40 include first folding mechanism 41 connected between the first column 11 and the second column 12, and second folding mechanism 42 connected between the third column 13 and the fourth column 14. The first folding mechanism 41 and the second folding mechanism 42 each include first linkage 411, second linkage 412, third linkage 413, fourth linkage 414, fifth linkage 415, and sixth linkage 416. The first linkage 411, the second linkage 412 and the third linkage 413 are rotatably connected end to end in sequence through a rotating shaft; and the fourth linkage 414, the fifth linkage 415 and the sixth linkage 416 are rotatably connected end to end in sequence through a rotating shaft. A middle of the first linkage 411 is rotatably connected to a middle of the fourth linkage 414 through a rotating shaft, a middle of the second linkage 412 is rotatably connected to a middle of the fifth linkage 415 through a rotating shaft, and a middle of the third linkage 413 is rotatably connected to a middle of the sixth linkage 416 through a rotating shaft. The first folding mechanism 41 and the second folding mechanism 42 have the same structure and symmetrical positions. Referring to FIG. 4, taking the mounting structure of the second folding mechanism 42 as an example, the first linkage 411 of the second folding mechanism 42 is rotatably connected to the fastener at an upper end of the fourth column 14 through a rotating shaft, and the third linkage 413 of the second folding mechanism 42 is rotatably connected to the third linkage slide sleeve 53 through a rotating shaft. The fourth linkage 414 of the second folding mechanism 42 is rotatably connected to the fourth linkage slide sleeve 54 through a rotating shaft, and the sixth linkage 416 of the second folding mechanism 42 is rotatably connected to the fastener at an upper end of the third column 13 through a rotating shaft. Similarly, the first linkage 411 of the first folding mechanism 41 is rotatably connected to the fastener at the upper end of the first column 11 through a rotating shaft, the third linkage 413 of the first folding mechanism 41 is rotatably connected to the second linkage slide sleeve 52 through a rotating shaft, the fourth linkage 414 of the first folding mechanism 41 is rotatably connected to the first linkage slide sleeve 51 through a rotating shaft, and the sixth linkage 416 of the first folding mechanism 41 is rotatably connected to the fastener at an upper end of the second column 12 through a rotating shaft. After the cart is unfolded, the first folding mechanism 41 and the second folding mechanism 42 are in the unfolded state, the first folding mechanism 41 is supported between the first column 11 and the second column 12, and the second folding mechanism 42 is supported between the third column 13 and the fourth column 14 for forming a side surrounding structure of the second-tier structure of the cart. In the unfolded state of the cart, the first folding mechanism 41 and the second folding mechanism 42 provide an upward tension for the four linkage slide sleeves, and the four linkage slide sleeves provide an upward tension for the second bottom support mechanism 22 to prevent the second bottom support mechanism 22 from sliding downward.

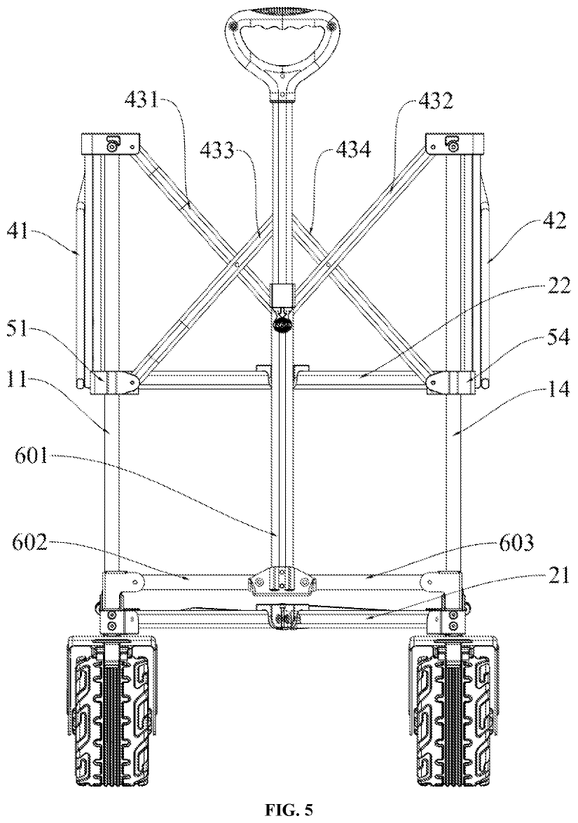

As shown in FIG. 5, the plurality of folding mechanisms 40 further include third folding mechanism 43 connected between the first column 11 and the fourth column 14, and fourth folding mechanism 44 connected between the second column 12 and the third column 13. The third folding mechanism 43 and the fourth folding mechanism 44 each include seventh linkage 431, eighth linkage 432, ninth linkage 433, and tenth linkage 434. A first end of the seventh linkage 431 is rotatably connected to a first end of the eighth linkage 432 through a rotating shaft, a first end of the ninth linkage 433 is rotatably connected to a first end of the tenth linkage 434 through a rotating shaft, a body of the seventh linkage 431 is rotatably connected to a body of the ninth linkage 433 through a rotating shaft, and a body of the eighth linkage 432 is rotatably connected to a body of the tenth linkage 434 through a rotating shaft. The third folding mechanism 43 and the fourth folding mechanism 44 have the same structure and symmetrical positions. Taking the mounting structure of the third folding mechanism 43 as an example, a second end of the seventh linkage 431 of the third folding mechanism 43 is rotatably connected to the fastener at the upper end of the first column 11 through a rotating shaft, a second end of the eighth linkage 432 of the third folding mechanism 43 is rotatably connected to the fastener at the upper end of the fourth column 14 through a rotating shaft, a second end of the ninth linkage 433 of the third folding mechanism 43 is rotatably connected to the first linkage slide sleeve 51 through a rotating shaft, and a second end of the tenth linkage 434 of the third folding mechanism 43 is rotatably connected to the fourth linkage slide sleeve 54 through a rotating shaft. Similarly, a second end of the seventh linkage 431 of the fourth folding mechanism 44 is rotatably connected to the fastener at the upper end of the second column 12 through a rotating shaft, a second end of the eighth linkage 432 of the fourth folding mechanism 44 is rotatably connected to the fastener at the upper end of the third column 13 through a rotating shaft, a second end of the ninth linkage 433 of the fourth folding mechanism 44 is rotatably connected to the second linkage slide sleeve 52 through a rotating shaft, and a second end of the tenth linkage 434 of the fourth folding mechanism 44 is rotatably connected to the third linkage slide sleeve 53 through a rotating shaft. After the cart is unfolded, the third folding mechanism 43 and the fourth folding mechanism 44 are in the unfolded state, the third folding mechanism 43 is supported between the first column 11 and the fourth column 14, and the fourth folding mechanism 44 is supported between the third column 13 and the second column 12 for forming a side surrounding structure of the second-tier structure of the cart. In the unfolded state of the cart, the third folding mechanism 43 and the fourth folding mechanism 44 provide an upward tension for the four linkage slide sleeves, and the four linkage slide sleeves provide an upward tension for the second bottom support mechanism 22 to prevent the second bottom support mechanism 22 from sliding downward.

As shown in FIG. 1, FIG. 2, and FIG. 5, the two-tier cart further includes handle 60 mechanism. The handle 60 mechanism includes telescopic rod 601, first connecting tube 602, and second connecting tube 603. A first end of the first connecting tube 602 and a first end of the second connecting tube 603 are both rotatably connected to a first end of the telescopic rod 601 by a limited angle, and a second end of the first connecting tube 602 and a second end of the second connecting tube 603 are rotatably connected in one-to-one correspondence with the lower end of the first column 11 and the lower end of the fourth column 14.

Specifically, a limiting member is connected to a lower end of the telescopic rod 601, a first end of the first connecting tube 602 is rotatably connected to a first side of the limiting member, a first end of the second connecting tube 603 is rotatably connected to a second side of the limiting member, the first side of the limiting member is opposite to the first column 11, and the second side of the limiting member is opposite to the fourth column 14. Restricted by the limiting member, the first connecting tube 602 and the second connecting tube 603 can only rotate downward from an inclined upward state in the folded state to the horizontal state in the unfolded state, or rotate upward from the horizontal state in the unfolded state. The first connecting tube 602 and the second connecting tube 603 cannot continue to rotate downward from the horizontal state. A second end of the first connecting tube 602 is rotatably connected to the lower end of the first column 11, and a second end of the second connecting tube 603 is rotatably connected to the lower end of the fourth column 14. When the first connecting tube 602 and the second connecting tube 603 rotate around a rotating shaft at the second end, a free end of the telescopic rod 601 moves away from the cart frame or moves close to the cart. When the free end of the telescopic rod 601 is far away from the cart, there is a certain angle between the telescopic rod 601 and a plane where the first column 11 and the fourth column 14 are located, which is convenient for a user to drag. The second end of the telescopic rod 601 is connected to a pull ring, which further facilitates the user to tow the cart. Rollers are respectively provided at a bottom of the first column 11, a bottom of the second column 12, a bottom of the third column 13 and a bottom of the fourth column 14. The rollers disposed at the bottom of the first column 11 and the bottom of the fourth column 14 are universal wheels, facilitating the traveling of the cart.

It should be understood that in the description of the present disclosure, terms such as “first” and “second” are used merely for a descriptive purpose, and should not be construed as indicating or implying relative importance, or implicitly indicating the number of indicated technical features. Thus, features defined with “first” and “second” may explicitly or implicitly include one or more of the features. In the description of the present disclosure, the term “a plurality of” means two or more, unless otherwise specifically defined.

In the present disclosure, unless otherwise clearly specified, the terms “installation”, “interconnection”, “connection” and “fixation” are intended to be understood in a broad sense. For example, the “connection” may be a fixed connection, removable connection or integral connection; may be a mechanical connection or electrical connection; may be a direct connection or indirect connection using a medium; and may be a communication or interaction between two elements. Those of ordinary skill in the art may understand the specific meanings of the above terms in the present disclosure based on specific situations.

In the present disclosure, unless otherwise explicitly stipulated, “a first feature is above or below a second feature” may indicate that “the first and second features are in direct contact” or “the first and second features are in indirect contact through an intermediate feature”. In addition, when it is described that the first feature is “over”, “above” and “on” the second feature, it indicates that the first feature is directly or obliquely above the second feature, or simply indicates that an altitude of the first feature is higher than that of the second feature. When it is described that a first feature is “under”, “below” or “beneath” a second feature, it indicates that the first feature is directly or obliquely under the second feature or simply indicates that the first feature is lower than the second feature.

In the description of this specification, the description with reference to the terms such as “one embodiment”, “some embodiments”, “embodiments”, “an example”, “a specific example” and “some examples” indicate that the specific features, structures, materials, or characteristics described with reference to the embodiment or example are included in at least one embodiment or example of the present disclosure. In this specification, the schematic expression of the above terms is not necessarily directed to the same embodiment or example. Moreover, the specific features, structures, materials, or characteristics described may be combined in a suitable manner in any one or more embodiments or examples. In addition, those skilled in the art may combine different embodiments or examples described in this specification and characteristics of the different embodiments or examples without mutual contradiction.

Although the embodiments of the present disclosure have been described above, it should be understood that the above embodiments are exemplary, and may not be construed as limitations to the present disclosure. A person of ordinary skill in the art may make various changes, modifications, replacements and variations on the above embodiments within the scope of the present disclosure.

What is claimed is:

1. A two-tier cart, comprising a first column, a second column, a third column, a fourth column, a first bottom support mechanism, a second bottom support mechanism, and a plurality of folding mechanisms, wherein
the first column, the second column, the third column and the fourth column are rectangularly arranged at intervals, and lower ends of the first column, the second column, the third column and the fourth column are all connected to the first bottom support mechanism, one folding mechanism is connected between two adjacent columns, and the plurality of folding mechanisms are allowed for being folded and contracted; and
the first column, the second column, the third column and the fourth column are all connected to the second bottom support mechanism, the second bottom support mechanism is located above the first bottom support mechanism, and the first bottom support mechanism and the second bottom support mechanism are both allowed for being folded and contracted upward.

2. The two-tier cart according to claim 1, further comprising a rear frame mechanism, wherein the rear frame mechanism is disposed between the second column and the third column, and a lower end of the rear frame mechanism is rotatably connected to the lower end of the second column and the lower end of the third column by a limited angle.

3. The two-tier cart according to claim 2, wherein the rear frame mechanism comprises a first rear frame column, a second rear frame column, and a rear frame folding assembly; and
the rear frame folding assembly is connected between the first rear frame column and the second rear frame column, a first end of the first rear frame column is rotatably connected to the lower end of the second column by a limited angle, and a first end of the second rear frame column is rotatably connected to the lower end of the third column by a limited angle.

4. The two-tier cart according to claim 3, wherein the first rear frame column and the second rear frame column are each slidably provided with a laying-down slide sleeve, a second end of the first rear frame column and a second end of the second rear frame column are each provided with a laying-down fastener, the laying-down fastener and the laying-down slide sleeve on the first rear frame column are both connected to the rear frame folding assembly, and the laying-down fastener and the laying-down slide sleeve on the second rear frame column are both connected to the rear frame folding assembly; and
the laying-down slide sleeve is provided with a clamping assembly, and the clamping assembly on the first rear frame column and the clamping assembly on the second rear frame column are allowed for being clamped in one-to-one correspondence with the second column and the third column.

5. The two-tier cart according to claim 4, wherein the rear frame folding assembly comprises a first cross bent tube, a second cross bent tube, a first cross straight tube, and a second cross straight tube;
the first cross bent tube is rotatably connected to the second cross bent tube, a first end of the first cross bent tube is rotatably connected to the laying-down fastener on the first rear frame column, and a first end of the second cross bent tube is rotatably connected to the laying-down slide sleeve on the first rear frame column;
the first cross straight tube is rotatably connected to the second cross straight tube, a first end of the first cross straight tube is rotatably connected to the laying-down fastener on the second rear frame column, and a first end of the second cross straight tube is rotatably connected to the laying-down slide sleeve on the second rear frame column; and
a second end of the first cross bent tube is rotatably connected to a second end of the first cross straight tube, and a second end of the second cross bent tube is rotatably connected to a second end of the second cross straight tube.

6. The two-tier cart according to claim 1, further comprising a first linkage slide sleeve, a second linkage slide sleeve, a third linkage slide sleeve, and a fourth linkage slide sleeve, wherein the first linkage slide sleeve, the second linkage slide sleeve, the third linkage slide sleeve and the fourth linkage slide sleeve are slidably connected in one-to-one correspondence with the first column, the second column, the third column and the fourth column;
the first linkage slide sleeve, the second linkage slide sleeve, the third linkage slide sleeve and the fourth linkage slide sleeve are all hinged to the second bottom support mechanism; and
both ends of the folding mechanism connected to the first column and the second column are connected in one-to-one correspondence with the first linkage slide sleeve and the second linkage slide sleeve; both ends of the folding mechanism connected to the second column and the third column are connected in one-to-one correspondence with the second linkage slide sleeve and the third linkage slide sleeve; both ends of the folding mechanism connected to the third column and the fourth column are connected in one-to-one correspondence with the third linkage slide sleeve and the fourth linkage slide sleeve; and both ends of the folding mechanism connected to the fourth column and the first column are connected in one-to-one correspondence with the fourth linkage slide sleeve and the first linkage slide sleeve.

7. The two-tier cart according to claim 6, wherein the second bottom support mechanism comprises a first bottom connector, a first bottom connecting tube, a second bottom connecting tube, a third bottom connecting tube, and a fourth bottom connecting tube; the first bottom support mechanism comprises a second bottom connector, a fifth bottom connecting tube, a sixth bottom connecting tube, a seventh bottom connecting tube, and an eighth bottom connecting tube;
first ends of the fifth bottom connecting tube, the sixth bottom connecting tube, the seventh bottom connecting tube and the eighth bottom connecting tube are all rotatably connected to the second bottom connector by a limited angle; second ends of the fifth bottom connecting tube, the sixth bottom connecting tube, the seventh bottom connecting tube and the eighth bottom connecting tube are rotatably connected in one-to-one correspondence with the lower ends of the first column, the second column, the third column and the fourth column; and
first ends of the first bottom connecting tube, the second bottom connecting tube, the third bottom connecting tube and the fourth bottom connecting tube are all rotatably connected to the first bottom connector by a limited angle; and second ends of the first bottom connecting tube, the second bottom connecting tube, the third bottom connecting tube and the fourth bottom connecting tube are rotatably connected in one-to-one correspondence with the first linkage slide sleeve, the second linkage slide sleeve, the third linkage slide sleeve and the fourth linkage slide sleeve.

8. The two-tier cart according to claim 7, wherein when the two-tier cart is in an unfolded state, a folded state, or in a process of being folded, the first bottom connecting tube, the second bottom connecting tube, the third bottom connecting tube and the fourth bottom connecting tube are always parallel to the fifth bottom connecting tube, the sixth bottom connecting tube, the seventh bottom connecting tube and the eighth bottom connecting tube in one-to-one correspondence;
when the two-tier cart is in the folded state, the first bottom connecting tube, the second bottom connecting tube, the third bottom connecting tube and the fourth bottom connecting tube are folded into a first tetrapyramid structure, the fifth bottom connecting tube, the sixth bottom connecting tube, the seventh bottom connecting tube and the eighth bottom connecting tube are folded into a second tetrapyramid structure, and the second tetrapyramid structure is sleeved in the first tetrapyramid structure; and
when the two-tier cart is in the folded state, a horizontal height of the first bottom connector is not higher than a horizontal height of an upper end of the first column.

9. The two-tier cart according to claim 6, wherein the plurality of folding mechanisms comprise: a first folding mechanism connected between the first column and the second column, a second folding mechanism connected between the third column and the fourth column, a third folding mechanism connected between the first column and the fourth column, and a fourth folding mechanism connected between the second column and the third column;
the first folding mechanism and the second folding mechanism each comprise a first linkage, a second linkage, a third linkage, a fourth linkage, a fifth linkage, and a sixth linkage;
the first linkage, the second linkage and the third linkage are rotatably connected end to end in sequence; the fourth linkage, the fifth linkage and the sixth linkage are rotatably connected end to end in sequence; a middle of the first linkage is rotatably connected to a middle of the fourth linkage, a middle of the second linkage is rotatably connected to a middle of the fifth linkage, and a middle of the third linkage is rotatably connected to a middle of the sixth linkage;
the first linkage of the first folding mechanism is rotatably connected to an upper end of the first column, the third linkage of the first folding mechanism is rotatably connected to the second linkage slide sleeve, the first linkage of the second folding mechanism is rotatably connected to an upper end of the fourth column, and the third linkage of the second folding mechanism is rotatably connected to the third linkage slide sleeve;
the fourth linkage of the first folding mechanism is rotatably connected to the first linkage slide sleeve, the sixth linkage of the first folding mechanism is rotatably connected to an upper end of the second column, the fourth linkage of the second folding mechanism is rotatably connected to the fourth linkage slide sleeve, and the sixth linkage of the second folding mechanism is rotatably connected to an upper end of the third column;
the third folding mechanism and the fourth folding mechanism each comprise a seventh linkage, an eighth linkage, a ninth linkage, and a tenth linkage;
a first end of the seventh linkage is rotatably connected to a first end of the eighth linkage, a first end of the ninth linkage is rotatably connected to a first end of the tenth linkage, a body of the seventh linkage is rotatably connected to a body of the ninth linkage, and a body of the eighth linkage is rotatably connected to a body of the tenth linkage;
a second end of the seventh linkage of the third folding mechanism is rotatably connected to the upper end of the first column, a second end of the eighth linkage of the third folding mechanism is rotatably connected to the upper end of the fourth column, a second end of the ninth linkage of the third folding mechanism is rotatably connected to the first linkage slide sleeve, and a second end of the tenth linkage of the third folding mechanism is rotatably connected to the fourth linkage slide sleeve; and
a second end of the seventh linkage of the fourth folding mechanism is rotatably connected to the upper end of the second column, a second end of the eighth linkage of the fourth folding mechanism is rotatably connected to the upper end of the third column, a second end of the ninth linkage of the fourth folding mechanism is rotatably connected to the second linkage slide sleeve, and a second end of the tenth linkage of the fourth folding mechanism is rotatably connected to the third linkage slide sleeve.

10. The two-tier cart according to claim 1, further comprising a handle mechanism, wherein the handle mechanism comprises a telescopic rod, a first connecting tube, and a second connecting tube, a first end of the first connecting tube and a first end of the second connecting tube are both rotatably connected to a first end of the telescopic rod by a limited angle, and a second end of the first connecting tube and a second end of the second connecting tube are rotatably connected in one-to-one correspondence with the lower end of the first column and the lower end of the fourth column.

11. The two-tier cart according to claim 2, further comprising a first linkage slide sleeve, a second linkage slide sleeve, a third linkage slide sleeve, and a fourth linkage slide sleeve, wherein the first linkage slide sleeve, the second linkage slide sleeve, the third linkage slide sleeve and the fourth linkage slide sleeve are slidably connected in one-to-one correspondence with the first column, the second column, the third column and the fourth column;
the first linkage slide sleeve, the second linkage slide sleeve, the third linkage slide sleeve and the fourth linkage slide sleeve are all hinged to the second bottom support mechanism; and
both ends of the folding mechanism connected to the first column and the second column are connected in one-to-one correspondence with the first linkage slide sleeve and the second linkage slide sleeve; both ends of the folding mechanism connected to the second column and the third column are connected in one-to-one correspondence with the second linkage slide sleeve and the third linkage slide sleeve; both ends of the folding mechanism connected to the third column and the fourth column are connected in one-to-one correspondence with the third linkage slide sleeve and the fourth linkage slide sleeve; and both ends of the folding mechanism connected to the fourth column and the first column are connected in one-to-one correspondence with the fourth linkage slide sleeve and the first linkage slide sleeve.

12. The two-tier cart according to claim 3, further comprising a first linkage slide sleeve, a second linkage slide sleeve, a third linkage slide sleeve, and a fourth linkage slide sleeve, wherein the first linkage slide sleeve, the second linkage slide sleeve, the third linkage slide sleeve and the fourth linkage slide sleeve are slidably connected in one-to-one correspondence with the first column, the second column, the third column and the fourth column;
the first linkage slide sleeve, the second linkage slide sleeve, the third linkage slide sleeve and the fourth linkage slide sleeve are all hinged to the second bottom support mechanism; and
both ends of the folding mechanism connected to the first column and the second column are connected in one-to-one correspondence with the first linkage slide sleeve and the second linkage slide sleeve; both ends of the folding mechanism connected to the second column and the third column are connected in one-to-one correspondence with the second linkage slide sleeve and the third linkage slide sleeve; both ends of the folding mechanism connected to the third column and the fourth column are connected in one-to-one correspondence with the third linkage slide sleeve and the fourth linkage slide sleeve; and both ends of the folding mechanism connected to the fourth column and the first column are connected in one-to-one correspondence with the fourth linkage slide sleeve and the first linkage slide sleeve.

13. The two-tier cart according to claim 4, further comprising a first linkage slide sleeve, a second linkage slide sleeve, a third linkage slide sleeve, and a fourth linkage slide sleeve, wherein the first linkage slide sleeve, the second linkage slide sleeve, the third linkage slide sleeve and the fourth linkage slide sleeve are slidably connected in one-to-one correspondence with the first column, the second column, the third column and the fourth column;
the first linkage slide sleeve, the second linkage slide sleeve, the third linkage slide sleeve and the fourth linkage slide sleeve are all hinged to the second bottom support mechanism; and
both ends of the folding mechanism connected to the first column and the second column are connected in one-to-one correspondence with the first linkage slide sleeve and the second linkage slide sleeve; both ends of the folding mechanism connected to the second column and the third column are connected in one-to-one correspondence with the second linkage slide sleeve and the third linkage slide sleeve; both ends of the folding mechanism connected to the third column and the fourth column are connected in one-to-one correspondence with the third linkage slide sleeve and the fourth linkage slide sleeve; and both ends of the folding mechanism connected to the fourth column and the first column are connected in one-to-one correspondence with the fourth linkage slide sleeve and the first linkage slide sleeve.

14. The two-tier cart according to claim 5, further comprising a first linkage slide sleeve, a second linkage slide sleeve, a third linkage slide sleeve, and a fourth linkage slide sleeve, wherein the first linkage slide sleeve, the second linkage slide sleeve, the third linkage slide sleeve and the fourth linkage slide sleeve are slidably connected in one-to-one correspondence with the first column, the second column, the third column and the fourth column;
the first linkage slide sleeve, the second linkage slide sleeve, the third linkage slide sleeve and the fourth linkage slide sleeve are all hinged to the second bottom support mechanism; and
both ends of the folding mechanism connected to the first column and the second column are connected in one-to-one correspondence with the first linkage slide sleeve and the second linkage slide sleeve; both ends of the folding mechanism connected to the second column and the third column are connected in one-to-one correspondence with the second linkage slide sleeve and the third linkage slide sleeve; both ends of the folding mechanism connected to the third column and the fourth column are connected in one-to-one correspondence with the third linkage slide sleeve and the fourth linkage slide sleeve; and both ends of the folding mechanism connected to the fourth column and the first column are connected in one-to-one correspondence with the fourth linkage slide sleeve and the first linkage slide sleeve.

15. The two-tier cart according to claim 2, further comprising a handle mechanism, wherein the handle mechanism comprises a telescopic rod, a first connecting tube, and a second connecting tube, a first end of the first connecting tube and a first end of the second connecting tube are both rotatably connected to a first end of the telescopic rod by a limited angle, and a second end of the first connecting tube and a second end of the second connecting tube are rotatably connected in one-to-one correspondence with the lower end of the first column and the lower end of the fourth column.

16. The two-tier cart according to claim 3, further comprising a handle mechanism, wherein the handle mechanism comprises a telescopic rod, a first connecting tube, and a second connecting tube, a first end of the first connecting tube and a first end of the second connecting tube are both rotatably connected to a first end of the telescopic rod by a limited angle, and a second end of the first connecting tube and a second end of the second connecting tube are rotatably connected in one-to-one correspondence with the lower end of the first column and the lower end of the fourth column.

17. The two-tier cart according to claim 4, further comprising a handle mechanism, wherein the handle mechanism comprises a telescopic rod, a first connecting tube, and a second connecting tube, a first end of the first connecting tube and a first end of the second connecting tube are both rotatably connected to a first end of the telescopic rod by a limited angle, and a second end of the first connecting tube and a second end of the second connecting tube are rotatably connected in one-to-one correspondence with the lower end of the first column and the lower end of the fourth column.

18. The two-tier cart according to claim 5, further comprising a handle mechanism, wherein the handle mechanism comprises a telescopic rod, a first connecting tube, and a second connecting tube, a first end of the first connecting tube and a first end of the second connecting tube are both rotatably connected to a first end of the telescopic rod by a limited angle, and a second end of the first connecting tube and a second end of the second connecting tube are rotatably connected in one-to-one correspondence with the lower end of the first column and the lower end of the fourth column.
